(19) United States
(12) Patent Application Publication
(10) Pub. No.: US 2013/0308192 A1
(43) Pub. Date: Nov. 21, 2013

(54) OPTICAL LAMINATED BODY, OPTICAL ELEMENT, AND PROJECTION DEVICE

(71) Applicant: SONY CORPORATION, Tokyo (JP)

(72) Inventor: KAZUHITO SHIMODA, Aichi (JP)

(73) Assignee: SONY CORPORATION, Tokyo (JP)

(21) Appl. No.: 13/861,677

(22) Filed: Apr. 12, 2013

(30) Foreign Application Priority Data
May 15, 2012 (JP) 2012-111291

(51) Int. Cl. G02B 1/11

(52) U.S. Cl. CPC G02B 1/11
USPC 359/581; 359/585

(57) ABSTRACT

An optical laminated body includes: a dielectric layer having a surface exposed to air; a metallic layer that has an interface with the dielectric layer, and contains at least Ag; and a laminated body that has an interface with the metallic layer and includes one or more low-refractive-index layers and one or more high-refractive-index layers, wherein a reflectance in a wavelength region of 460 to 650 nm is 0.1% or less.

### FIELD

The present disclosure relates to an optical laminated body, an optical element, and a projection device. Particularly, the present disclosure relates to an optical laminated body, an optical element, and a projection device that are advantageous for reduction in size of an optical system.

### BACKGROUND

In light-transmissive optical components such as a lens and filter, it is necessary to suppress reflection on a surface thereof.

In recently years, accompanying reduction in size of electronic apparatuses, reduction in size of an optical component has been also demanded. Therefore, it is demanded to secure necessary optical characteristics while reducing the size of the optical component.

However, as the size of the optical component is reduced, design restrictions of an optical system increase. Therefore, for example, an antireflective film, which is configured to reduce reflection on the surface of the optical component, has been demanded to have a relatively low reflectance.

Japanese Patent No. 2590133 discloses a transparent plate including a transparent substrate, a metallic film, a high-refractive-index dielectric film, and a low-refractive-index dielectric film. Japanese Patent No. 3934742 discloses an antireflective film including a substrate, a layer formed from titanium nitride, a high-refractive-index layer, and a low-refractive-index layer. In addition, JP-A-2004-334012 discloses a three-layer or four-layer antireflective film using Ag (silver).

### SUMMARY

It is desirable to realize relatively low reflection so as to reduce reflection on a surface of an optical component.

A first preferred embodiment of the present disclosure is directed an optical laminated body including a dielectric layer, a metallic layer, and a laminated body. The dielectric layer has a surface exposed to air. The metallic layer has an interface with the dielectric layer, and contains at least Ag. The laminated body has an interface with the metallic layer and includes one or more low-refractive-index layers and one or more high-refractive-index layers. A reflectance in a wavelength region of 460 to 650 nm is 0.1% or less.

A second preferred embodiment of the present disclosure is directed to an optical element including a dielectric layer, a metallic layer, a laminated body, and a light-transmissive base body. The dielectric layer has a surface exposed to air. The metallic layer has an interface with the dielectric layer, and contains at least Ag. The laminated body has an interface with the metallic layer and includes one or more low-refractive-index layers and one or more high-refractive-index layers. The light-transmissive base body has an interface with the laminated body.

A third preferred embodiment of the present disclosure is directed to a projection device including a light source, a modulation unit. The modulation unit includes one or more lenses, and overlaps image information on light emitted from the light source. At least one lens among the one or more lenses includes a dielectric layer, a metallic layer, a laminated body, and a lens base body. The dielectric layer has a surface exposed to air. The metallic layer has an interface with the dielectric layer and contains at least Ag. The laminated body has an interface with the metallic layer and includes one or more low-refractive-index layers and one or more high-refractive-index layers. The lens base body has an interface with the laminated body.

The optical laminated body according to the embodiment of the present disclosure includes the metallic layer that contains at least Ag (silver).

For example, a metallic film may be included in an antireflective film so as to apply conductivity to the antireflective film or the like. However, when the metallic film is contained in the antireflective film, a reflectance decreases, but a metal absorbs light and thus a transmittance greatly decreases. Therefore, in general, a metal is not used for coating of an optical component such as a lens in which a high transmittance is demanded. The antireflective film is constituted by repetitively laminating approximately several tens of layers including a layer formed from a high-refractive-index material and a layer formed from a low-refractive-index material.

Conversely, in the embodiment of the present disclosure, a layer, which is adjacent to a layer having a surface exposed to air, of the optical laminated body, is configured as a layer containing at least Ag. The present inventors have found that when the layer containing at least Ag is included in the optical laminated body, the number of layers of the optical laminated body having an antireflection function may be reduced to approximately ten. The present inventors have made a further thorough investigation, and as a result, they have found an optical laminated body capable of realizing a low reflectance in a visible light region with a relatively small number of layers by disposing the layer containing at least Ag adjacently to the layer having a surface exposed to air.

In this specification, “visible light region” represents a wavelength region of 450 to 650 nm.

In this specification, “low refractive index” represents a case in which a refractive index at a D-line (589.3 nm) of sodium is less than 1.7. In addition, in this specification, “high refractive index” represents a case in which the refractive index at the D-line of sodium is 1.7 or more.

In this specification, when “layer thickness” or “thickness” is referred with regard to an optical layer that constitutes an antireflective film or an optical laminated body, these represent a geometric film thickness that is measured along a normal line direction of a main surface on which the optical layer is formed.

According to at least one example, reflection of incident light may be further reduced.

### BRIEF DESCRIPTION OF THE DRAWINGS

FIG. 1A is a schematic diagram illustrating a cross-section of an optical laminated body according to a first embodiment of the present disclosure, FIG. 1B is a schematic diagram illustrating a cross-section of a first configuration example of the optical laminated body according to the first embodiment, and FIG. 1C is a schematic diagram illustrating a cross-section of a second configuration example of the optical laminated body according to the first embodiment;

FIG. 2A is a schematic diagram illustrating a cross-section of an optical element according to a second embodiment of the present disclosure, and FIG. 2B is an enlarged schematic diagram illustrating an SB portion indicated by a broken line in FIG. 2A;

FIG. 3 is a block diagram illustrating a configuration example of a projection device according to a third embodiment of the present disclosure;

FIG. 4A is a schematic diagram illustrating a configuration example of a modulation unit, and FIG. 4B is a schematic diagram illustrating another configuration example of the modulation unit;

FIG. 5 is a diagram illustrating a simulation result with respect to an optical laminated body of Test Example 1-1;

FIG. 6A is a diagram illustrating a simulation result with respect to an optical laminated body of Comparative Example 1-1, and FIG. 6B is a diagram illustrating a simulation result with respect to an optical laminated body of Comparative Example 1-2;

FIG. 7A is a diagram illustrating a simulation result with respect to an optical laminated body of Comparative Example 1-3, and FIG. 7B is a diagram illustrating a simulation result with respect to an optical laminated body of Comparative Example 1-4;

FIG. 8A is a diagram illustrating simulation results with respect to optical laminated bodies of Test Example 2-1, and Comparative Examples 2-1 and 2-2, and FIG. 8B is a diagram illustrating simulation results with respect to optical laminated bodies of Test Example 2-2, and Comparative Examples 2-3 and 2-4;

FIG. 9A is a diagram illustrating simulation results with respect to optical laminated bodies of Test Examples 3-1 and 3-2, and Comparative Examples 3-1 and 3-2, FIG. 9B is a diagram illustrating a simulation result with respect to an optical laminated body of Reference Example 3-1;

FIG. 10A is a diagram illustrating a simulation result with respect to an optical laminated body of Test Example 4-1, and FIG. 10B is a diagram illustrating simulation results with respect to optical laminated bodies of Test Examples 4-2 and 4-3; and

FIG. 11A is a diagram illustrating simulation results with respect to optical laminated bodies of Comparative Examples 4-1 and 4-2, and FIG. 11B is a diagram illustrating a simulation result with respect to an optical laminated body of Test Example 4-4.

### DETAILED DESCRIPTION

Hereinafter, embodiments of an optical laminated body, an optical element, and a projection device will be described. Description will be made in the following order.

1. First Embodiment

1-1. Schematic Configuration Optical Laminated Body

1-1-1. Dielectric Layer

1-1-2. Metallic Layer

1-1-3. Laminated Body

1-2. First Configuration Example of Optical Laminated Body

1-3. Second Configuration Example of Optical Laminated Body

2. Second Embodiment

2-1. Schematic Configuration of Optical Element

2-1-1. Light-transmissive Base Body

2-1-2. Optical Laminated Body

3. Third Embodiment

3-1. Schematic Configuration of Projection Device

3-2. Configuration Example of Projection Device

3-2-1. Light Source

3-2-2. Modulation Unit

4. Modification Example

In addition, embodiments to be described below are specific examples that are very suitable for an optical laminated body, an optical element, and a projection device. In the following description, technically preferable various limitations are added, but examples of the optical laminated body, the optical element, and the projection device are not limited to the following embodiments as long as description particularly limiting the present disclosure is not made.

### 1. First Embodiment

### 1-1. Schematic Configuration of Optical Laminated Body

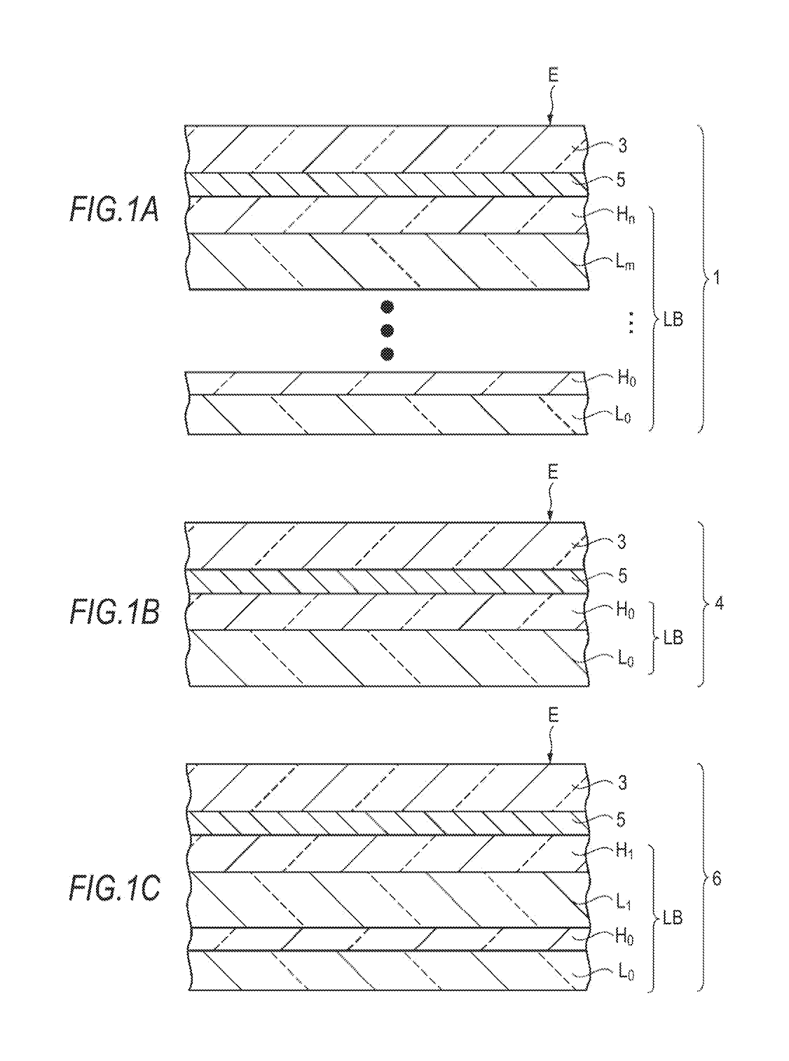

FIG. 1A shows a schematic diagram illustrating a cross-section of an optical laminated body according to the first embodiment of the present disclosure.

As shown in FIG. 1A, an optical laminated body 1 includes a dielectric layer 3, a metallic layer 5 that contains at least Ag, and a laminated body LB. In addition, as shown in FIG. 1A, the metallic layer 5 is interposed between the dielectric layer 3 having a surface E exposed to air, and the laminated body LB. That is, the metallic layer 5 has an interface with the dielectric layer 3 having the surface E exposed to air, and the laminated body LB has an interface with the metallic layer 5.

The laminated body LB includes one or more low-refractive-index layers Lᵢ (i=0, 1, 2, . . . , m (m is 0 or a positive integer)) and one or more high-refractive-index layers Hⱼ (j=0, 1, 2, . . . , n (n is 0 or a positive integer)). Accordingly, the optical laminated body 1 is constituted as a laminated body of at least four layers or more.

Each of the low-refractive-index layers Lᵢ is a layer formed from a low-refractive-index material, and each of the high-refractive-index layers Hⱼ is a layer formed from a high-refractive-index material. In the embodiment of the present disclosure, the layer formed from the low-refractive-index material is appropriately referred to as a low-refractive-index layer, and the layer formed from the high-refractive-index material is appropriately referred to as a high-refractive-index layer.

As described later, the optical laminated body 1 is an optical body having a reflectance of 0.1% or less in a wavelength region of 460 to 650 nm. Specifically, the optical laminated body 1 is an optical body that is applicable as, for example, an antireflective film.

Hereinafter, description will be made with respect to the dielectric layer 3, the metallic layer 5, and the laminated body LB in this order.

### (1-1-1. Dielectric Layer)

The dielectric layer 3 is a layer having a surface E exposed to air. It is preferable that the dielectric layer 3 be constituted by, for example, a low-refractive-index layer. This is because when the dielectric layer 3 is constituted by a high-refractive-index layer, a percentage of light that is reflected on an interface with air increases and thus a transmittance of the optical laminated body 1 decreases compared to a case where the dielectric layer 3 is constituted as a low-refractive-index layer. In addition, when the layer having the surface E exposed to air is constituted by a low-refractive-index layer, optical design becomes simple compared to a case in which the layer having the surface E exposed to air is constituted by a high-refractive-index layer.

In a case where the dielectric layer 3 is constituted by a low refractive-index layer, examples of a low-refractive-index material that constitutes this layer include SiO₂, MgF₂, AlF₃, and the like, but there is no limitation thereto. In addition, in a case where the dielectric layer 3 is formed by a deposition method, it is preferable to select SiO₂ as the material that constitutes the dielectric layer 3. This is because SiO₂ is suitable for the deposition method that is a representative mass-production process.

The thickness of the dielectric layer 3 is preferably set to 100 nm or less. This is because the metallic layer 5 to be described later may be allowed to function as a conductive layer, and thus an anti-dust effect due to exhibition of conductivity may be expected.

### (1-1-2. Metallic Layer)

The metallic layer 5 is a layer that is disposed adjacently to the dielectric layer 3 and has an interface with the dielectric layer 3. Accordingly, the metallic layer 5 is a layer that is disposed at the second position from the side of the surface E exposed to air in correspondence with a case in which the dielectric layer 3 has the surface E exposed to air.

The metallic layer 5 according to the embodiment of the present disclosure is a layer containing at least Ag. Here, containing of Ag covers a case in which the metallic layer 5 is constituted by Ag, but also a case in which the metallic layer 5 is constituted by an alloy containing Ag.

For example, it is preferable that the metallic layer 5 be a layer doped with an element other than Ag. This is because corrosion resistance of the metallic layer 5 may be improved without changing optical characteristics such as a refractive index and an absorption coefficient of Ag. Accordingly, it is preferable that the metallic layer 5 contain at least one or more kinds selected from a group consisting of Pd (palladium), Cu (copper), Au (gold), Nd (neodymium), Sm (samarium), Bi (bismuth), and Pt (platinum). Specifically, as the material that constitutes the metallic layer 5, for example, Ag—Pd, Ag—Pd—Cu, and the like are suitable.

### (1-1-3. Laminated Body)

The laminated body LB is disposed adjacently to the metallic layer 5 and has an interface with the metallic layer 5. As described above, the laminated body LB includes one or more low-refractive-index layers Lᵢ and one or more high-refractive-index layers Hⱼ. That is, the laminated body LB is constituted by a laminated body of at least two or more layers.

Examples of a material that constitutes each of the one or more low-refractive-index layers Lᵢ include SiO₂, MgF₂, AlF₂, and the like, but there is no limitation thereto. Of course, two or more kinds of materials may be used as a material constituting each of the one or more low-refractive-index layers Lᵢ.

Examples of a material that constitutes each of the one or more high-refractive-index layers Hⱼ include metal oxides. Examples of the metal oxides include TiO₂, Nb₂O₅, Ta₂O₅, ZrO₂, and the like, but there is no limitation thereto. For example, as a material that constitutes each of the one or more high-refractive-index layers Hⱼ, any one of In₂O₂, SnO₂, ZnO, ITO, and alloys thereof, or a transparent conductive material obtained by doping ZnO with Al (aluminum) or Ga (gallium) may be used. Of course, two or more kinds of materials may be used as the material that constitutes each of the one or more high-refractive-index layers Hⱼ.

In addition, FIG. 1A shows an example in which a layer having an interface with the metallic layer 5 is constituted by a high-refractive-index layer Hₙ, but the layer having an interface with the metallic layer 5 may be constituted by a low-refractive-index layer Lₘ. In addition, FIG. 1A shows an example in which among the high-refractive-index layers Lᵢ and the low-refractive-index layers Hⱼ, a layer located at the farthest position from the dielectric layer 3 is constituted by a low-refractive-index layer L₀, but the layer located at the farthest position from the dielectric layer 3 may be constituted by a high-refractive-index layer H₀.

### 1-2. First Configuration Example of Optical Laminated Body

FIG. 1B shows a schematic diagram illustrating a cross-section of the first configuration example of the optical laminated body according to the first embodiment.

In an optical laminated body 4 shown in FIG. 1B, the laminated body LB is constituted by a laminated body of one low-refractive-index layer L₀ and one high-refractive-index layer H₀. In other words, the optical laminated body 4 shown in FIG. 1B has a laminated structure of four layers as a whole.

As described above, a general antireflection film is constituted by repetitively laminating approximately several tens of layers including a layer formed from a high-refractive-index material and a layer formed from a low-refractive-index material. For example, it is possible to obtain a reflectance of 0.1% or less in a wavelength region of 460 to 650 nm by repetitively laminating only the layer formed from the high-refractive-index material and the layer formed from the low-refractive-index material. However, in a case of forming the antireflective film by repetitively laminating the layer formed from the high-refractive-index material and the layer formed from the low-refractive-index material, the manufacturing cost of the antireflective film or a lead time increases, and thus production becomes difficult. In addition, when the number of layers constituting the antireflective film is large, internal stress increases, and thus peeling or cracking may occur between layers.

On the other hand, according to the embodiment of the present disclosure, a low reflectance may be realized by a relatively small number of layers such as four layers as a whole.

In a case of constituting the optical laminated body 4 with a laminated structure of four layers as a whole, it is preferable that the high-refractive-index layer H₀ have an interface with the metallic layer 5, and the thickness of the low-refractive-index layer L₀ be set to be equal to or more than 150 nm and less than 510 nm, more preferably equal to or more than 150 nm and less than 340 nm.

For example, the optical laminated body according to the first embodiment is formed on a transparent base body that has light-transmitting properties, and is formed from glass or a transparent resin. At this time, according to a finding obtained by the present inventors, when a layer adjacent to a main surface of the transparent base body is constituted by a layer formed from a low-refractive-index material, and the thickness of the layer formed from the low-refractive-index material is made to vary continuously, the reflectance of the optical laminated body varies in an approximately periodic manner.

For example, in a case of increasing the thickness of the low-refractive-index layer L₀, whenever the thickness of the low-refractive-index layer L₀ becomes an integral multiple of approximately 170 nm, the reflectance of the optical laminated body in the wavelength region of 460 to 650 nm decreases as a whole.

In addition, for example, in a case of increasing the thickness of the low-refractive-index layer L₀, whenever the thickness of the low-refractive-index layer L₀ increases by approximately 170 nm, the reflectance of the optical laminated body becomes the maximum. That is, for example, when the low-refractive-index layer L₀ is constituted by a layer formed from SiO₂, and the thickness of the low-refractive-index layer Lois set to approximately 350 nm, the reflectance of the optical laminated body 4 in a visible light region shows two maximum values. In addition, all of the maximum values at this time are 0.1 or less.

In other words, for example, in a case of using transmitted light from the optical laminated body 4, in the optical laminated body 4, a reflectance near the peak wavelength of a wavelength spectrum of a light source may be selectively set to be low. That is, the minimum reflectance of the optical laminated body 4 may be set near the peak wavelength of the wavelength spectrum of the light source by adjusting the thickness of the low-refractive-index layer L₀. Here, the “near” represents a range of ±10 nm of an arbitrary wavelength.

Specifically, for example, when the thickness of the low-refractive-index layer L₀ is set to approximately 350 nm, the reflectance of the optical laminated body 4 in a visible region may show three minimum values. For example, it is assumed that light emitted from blue, green, and red light-emitting diodes (LED) is made to transmit through the optical laminated body 4. At this time, when a reflectance near a wavelength of 470 nm, near a wavelength of 530 nm, and near a wavelength of 630 nm is selectively set to be low, loss of light emitted from a light source may be reduced. Accordingly, according to the embodiment of the present disclosure, light emitted from the light source may be effectively used.

In addition, from the viewpoints of reduction in the manufacturing cost or the lead time, it is preferable that the thickness of the low-refractive-index layer L₀ be set to be equal to or more than 150 nm and less than 340 nm.

Here, in a case of constituting the optical laminated body 4 with a laminated structure of four layers as a whole, it is preferable that the thickness of the metallic layer 5 be set to 6.1 to 6.5 nm.

The antireflective film, which is disclosed in Japanese Patent Nos. 2590133 and 3934742 as a related technology, includes a metallic film in the antireflective film. In a case where the antireflective film includes the metallic film, generally, a reflectance and a transmittance have a trade-off relationship.

In the antireflective film disclosed in Japanese Patent No. 2590133, as a material that constitutes the metallic film, Ti (titanium), Cr (chromium), Zr (zirconium), Mo (molybdenum), Ni—Cr (nickel-chromium alloy), or stainless steel is selected. According to the technology disclosed in Japanese Patent No. 2590133, a reflectance of approximately 0.2% and a transmittance of approximately 65% are obtained in a wavelength band of approximately 500 to 570 nm. In the antireflective film disclosed in Japanese Patent No. 3934742, TiN (titanium nitride) is selected as a material that constitutes the metallic film. According to the technology disclosed in Japanese Patent No. 3934742, a reflectance of approximately 0.2% and a transmittance of approximately 50% are obtained in a wavelength band of approximately 450 to 630 nm.

On the other hand, according to the embodiment of the present disclosure, as the material that constitutes the metallic layer 5, a material that contains at least Ag is selected. When the material that contains at least Ag is used for the metallic layer 5, and the thickness of the metallic layer 5 is adjusted, even in a relatively small number of layers such as four layers as a whole, a reflectance of 0.1% or less in a visible light region may be obtained while securing a high transmittance of 90% or more in the visible light region.

### 1-3. Second Configuration Example of Optical Laminated Body

FIG. 1C shows a schematic diagram illustrating a cross-section of a second configuration example of the optical laminated body according to the first embodiment.

An optical laminated body 6 shown in FIG. 1C is different from the optical laminated body 4 shown in FIG. 1B in that the laminated body LB is constituted by a laminated body including two or more low-refractive-index layers Lᵢ and two or more high-refractive-index layers Hⱼ. In other words, the optical laminated body 6 shown in FIG. 1C has a laminated structure of six layers as a whole.

In addition, FIG. 1C shows an example in which a layer having an interface with the metallic layer 5 is constituted by a high-refractive-index layer Hₙ, but the layer having an interface with the metallic layer 5 may be constituted by a low-refractive-index layer Lₘ. In addition, FIG. 1C shows an example in which among the high-refractive-index layers Lᵢ and the low-refractive-index layers Hⱼ, a layer located at the farthest position from the dielectric layer 3 is constituted by a low-refractive-index layer L₀, but the layer located at the farthest position from the dielectric layer 3 may be constituted by a high-refractive-index layer H₀.

Here, in a case of constituting the optical laminated body 6 with a laminated structure of six layers as a whole, it is preferable that the thickness of the metallic layer 5 be set to 5.5 to 6.2 nm. When the thickness of the metallic layer 5 is set to 5.5 to 6.2 nm, a reflectance of 0.1% or less in a visible light region may be obtained.

In this manner, when the number of layers of the optical laminated body is increased to six or more, a low reflectance may be obtained in a relatively wide wavelength region compared to a case in which the number of layers of the optical laminated body is four.

As described above, according to the embodiment of the present disclosure, a layer that contains at least Ag is used as the metallic layer, and thus optical design is optimized. Accordingly, when being compared to a general antireflective film, a transmittance may be increased while realizing a low reflectance in a visible light region due to a relatively small number of layers. Since the optical laminated body according to the first embodiment of the present disclosure is constituted with a relatively small number of layers compared to a general antireflective film, the entirety of the optical laminated body may be configured to be thin, and cracking or peeling due to internal stress may be reduced.

Furthermore, according to the embodiment of the present disclosure, the reflectance near the peak wavelength of the light source may be selectively decreased, and thus light utilizing efficiency of light emitted from the light source may be improved. In addition, in the optical laminated body according to the first embodiment of the present disclosure, since the metallic layer that contains at least Ag is disposed adjacently to the layer having a surface exposed to air, thus an anti-dust effect due to exhibition of conductivity may be expected.

### 2. Second Embodiment

### 2-1. Schematic Configuration of Optical Element

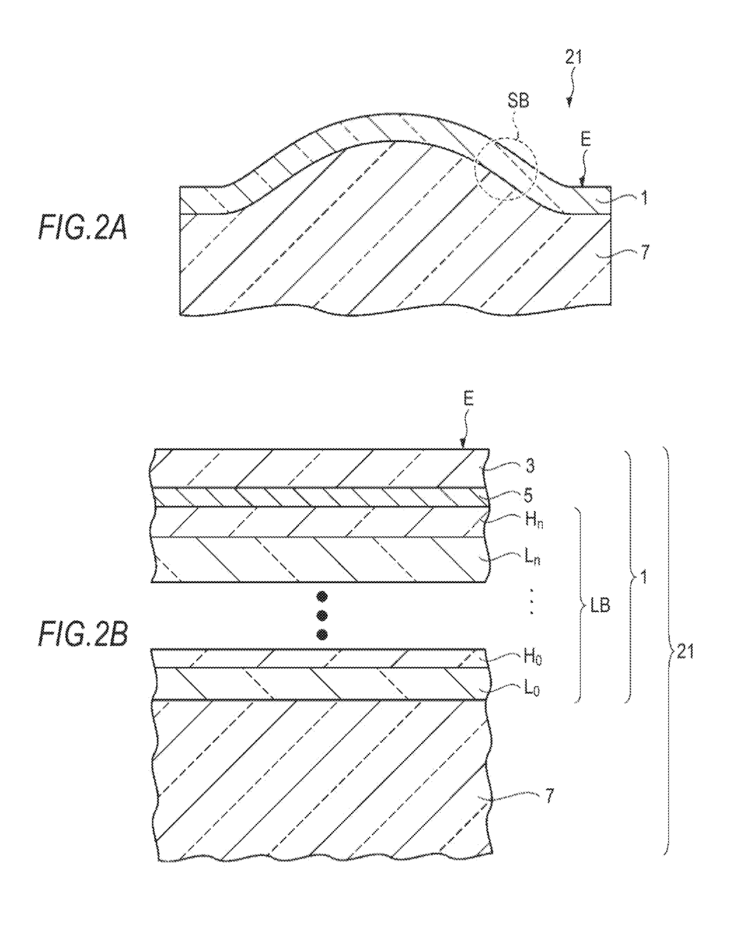

FIG. 2A is a schematic diagram illustrating a cross-section of an optical element according to a second embodiment of the present disclosure. FIG. 2B is an enlarged schematic diagram illustrating an SB portion indicated by a broken line in FIG. 2A.

An optical element 21 according to the second embodiment includes a coating for antireflection on a main surface of a light-transmissive base body 7. The coating for antireflection, which is formed on the main surface of the light-transmissive base body 7, is substantially the same laminated body as, for example, the optical laminated body 1 according to the first embodiment.

That is, as shown in FIG. 2A, the optical element 21 includes the light-transmissive base body 7 and the optical laminated body 1. More specifically, as shown in FIG. 2B, a laminated body LB including one or more low-refractive-index layers Lᵢ and one or more high-refractive-index layers Hⱼ is disposed on the light-transmissive base body 7, and a metallic layer 5 that contains at least Ag is disposed on the laminated body LB. Furthermore, a dielectric layer 3 is disposed on the metallic layer 5. A surface of the dielectric layer 3, which corresponds to a surface of the optical element 21, becomes a surface E exposed to air.

Accordingly, as shown in FIG. 2B, the metallic layer 5 has an interface with the dielectric layer 3 having the surface E exposed to air, and the laminated body LB has an interface with the metallic layer 5. In addition, the light-transmissive base body 7 has an interface with the laminated body LB.

In addition, FIG. 2B shows an example in which a layer having an interface with the metallic layer 5 is constituted by a high-refractive-index layer Hₙ, but the layer having an interface with the metallic layer 5 may be constituted by a low-refractive-index layer Lₘ. In addition, FIG. 2B shows an example in which among the high-refractive-index layers Lᵢ and the low-refractive-index layers Hⱼ, a layer located at the farthest position from the dielectric layer 3 is constituted by a low-refractive-index layer L₀, but the layer located at the farthest position from the dielectric layer 3 may be constituted by a high-refractive-index layer H₀.

### (2-1-1. Light-Transmissive Base Body)

The light-transmissive base body 7 is a transparent supporting base body with respect to the optical laminated body 1.

Examples of a material that constitutes the light-transmissive base body 7 include various kinds of glass, quartz, sapphire, CaF₂ (calcium fluoride), KTaO₃, a resin material, and the like. As the resin material, for example, polymethyl methacrylate, polycarbonate (PC), cycloolefin polymer (COP), polyethyleneterephtalate (PET), polyethersulphone (PES), polyethylenenaphthalate (PEN), triacetylcellulose (TAC), polyimide, aramid (aromatic polyamide), or the like may be used.

A shape of a surface of the light-transmissive base body 7 on which the optical laminated body 1 is formed is not particularly limited, and may be a planar shape, a curve shape, or a concavo-convex shape, or a combination of these shapes.

The optical element 21 is an optical component that allows light emitted from a light source to transmit therethrough in order for the transmitted light to be used. Specific examples of the optical element 21 include a lens, a prism, an optical filter, and the like. FIG. 2A shows an example in which the optical element 21 is constituted by a convex lens, but needless to say, the optical element 21 may be a concave lens. Of course, the type of the lens is not particularly limited.

### (2-1-2. Optical Laminated Body)

The optical element 21 has substantially the same laminated body as the optical laminated body 1 according to the first embodiment in a surface thereof. That is, the optical laminated body 1 shown in FIGS. 2A and 2B is constituted by a laminated body of at least four layers.

In a case where the optical laminated body 1 formed on the main surface of the light-transmissive base body 7 is constituted with four layer as a whole, it is preferable that a layer located at a farthest position from the dielectric layer 3 be constituted by a low-refractive-index layer L₀, and the thickness of the low-refractive-index layer L₀ be set to be equal to or more than 150 nm and less than 510 nm. This is because the reflectance of the optical laminated body 1 in a wavelength region of 460 to 650 nm may be decreased as a whole.

As a method of forming the optical laminated body 1 on one main surface of the light-transmissive base body 7, a dry process such as a sputtering method, a deposition method, and a chemical vapor deposition (CVD) is applicable.

According to the second embodiment, an optical element, in which reflection on a surface is reduced and which has a high transmittance, may be provided.

### 3. Third Embodiment

### 3-1. Schematic Configuration of Projection Device

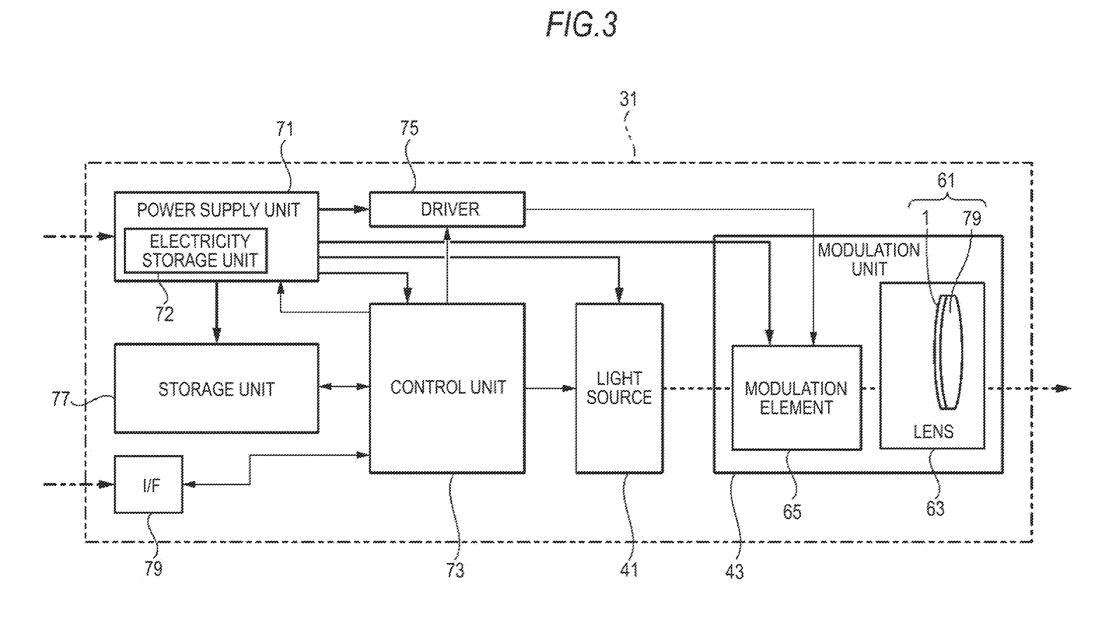

FIG. 3 shows a block diagram illustrating a configuration example of a projection device according to the third embodiment of the present disclosure.

As shown in FIG. 3, the projection device 31 includes a light source 41 and a modulation unit 43. The modulation unit 43 includes one or more lenses 63, and a modulation element 65 that overlaps image information on light emitted from the light source 41 as necessary.

Among the one or more lenses 63, at least one lens has substantially the same configuration as the optical element 21 according to the second embodiment. Hereinafter, the lens having substantially the same configuration as the optical element 21 according to the second embodiment is described as “lens 61 and the like”.

That is, the lens 61 includes the dielectric layer 3 having a surface exposed to air, the metallic layer 5 that contains at least Ag, the laminated body LB including the one or more low-refractive-index layers Lᵢ and the one or more high-refractive-index layers Hⱼ, and a lens base body 9 as the light-transmissive base body 7. In addition, the metallic layer 5 has an interface with the dielectric layer 3, the laminated body LB has an interface with the metallic layer 5, and the lens base body 9 has an interface with the laminated body LB.

Specifically, the projection device 31 according to the third embodiment is a projection device that projects an image on a screen or a wall surface.

However, it is necessary for an optical system embedded in the projection device to have a small size for realizing reduction in size of the projection device.

However, along with the reduction in size of the optical system, there is a tendency for an image quality of an image projected on the screen or the like to deteriorate. For example, when an image is projected on the screen or the like using a small-sized projection device, an image of the projection device, which is not intended by a user (hereinafter, this image is appropriately referred to as “ghost”), may be overlapped on the image projected to the screen.

When the size of the projection device is reduced, design restrictions of an optical system increase. Therefore, in a small-sized projection device, it is difficult to suppress occurrence of ghost through a design scheme of the optical system.

It is guessed that the light incident to the optical element that is used in the optical system is multi-reflected inside the optical element and thus the ghost occurs. That is, suppression of reflection of light incident to the optical element that is used in the optical system is effective for preventing the ghost from occurring. To suppress occurrence of the ghost, it is necessary to constitute the optical element used in the optical system of the projection device by an optical element having a low reflectance and a high transmittance with respect to incident light.

As will be clear from the following description, the projection device according to the third embodiment is a projection device capable of suppressing occurrence of the ghost.

### 3-2. Configuration Example of Projection Device

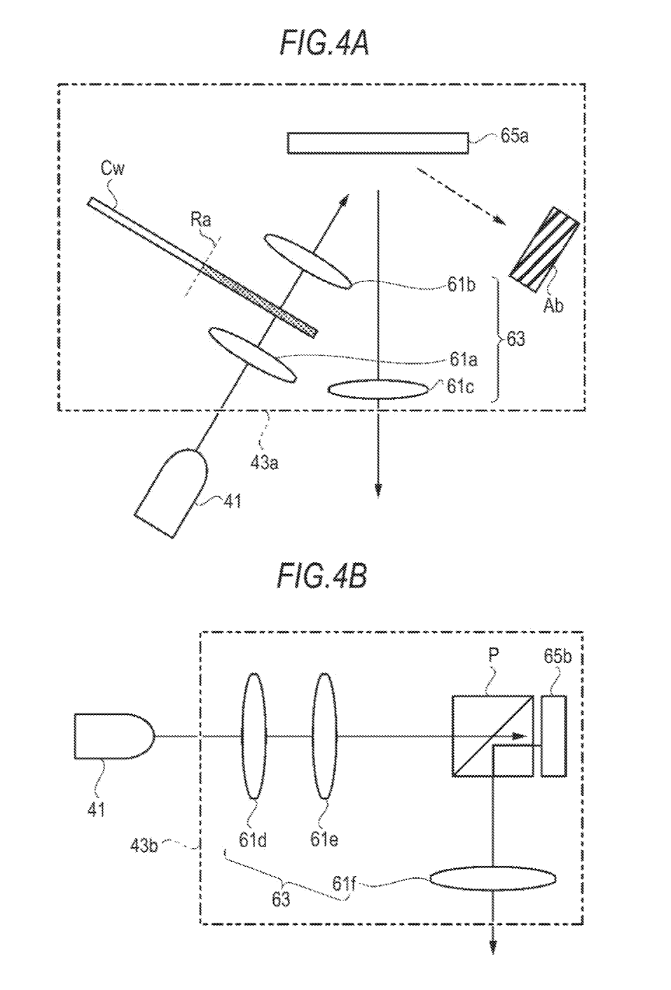

Hereinafter, details of a configuration example of the projection device according to the third embodiment will be described with reference to FIGS. 3, 4A, and 4B.

A power supply unit 71 supplies power for driving respective units of the projection device 31 to the respective units of the projection device 31. From the power supply unit 71, power is supplied to, for example, a control unit 73, a driver 75, a storage unit 77, the light source 41, the modulation element 65, and the like. Power from, for example, a commercial power supply is supplied to the power supply unit 71, and the power supply unit 71 carries out AC (Alternate Current)-DC (Direct Current) conversion or a voltage conversion as necessary. In a case where the power supply unit 71 is provided with an electricity storage unit 72 constituted by a battery, a capacitor, and the like, the power supply unit is configured in such a manner that charging to the electricity storage unit 72 or discharging from the electricity storage unit 72 are possible.

The control unit 73 controls the respective units of the projection device 31. For example, the control unit 73 sends a control signal with respect to the driver 75 that drives the modulation element 65, a control signal that controls turning-on and turning-off of the light source 41, and the like. The control unit 73 is a processing device including a process, a memory, and the like, and the control unit 73 is constituted as, for example, a digital signal processor (DSP) or a CPU (central processing unit).

The storage unit 77 is a storage medium that stores data related to an image (hereinafter, appropriately referred to as a “projection image”) to be projected to the screen or the like. The data related to the projection image is supplied to the projection device 31 from an external apparatus such as a personal computer or over the internet via an external interface 79. In addition, the data stored in the storage unit 77 is read out by the control unit 73, and the control unit 73 generates a control signal corresponding to the projection image and supplies this control signal to the driver 75. The storage unit 77 is constituted by, for example, a hard disk, a flash memory, an optical disc, an optical-magneto disc, a MRAM (Magneto-resistive Random Access Memory: Magneto-resistive memory), or the like.

### (3-2-1. Light Source)

The light source 41 is an assembly of one or more light sources that supply light for forming an image of the projection image on the screen or the like. Examples of a kind of the light source 41 include an LED, a metal halide lamp, a halogen lamp, a xenon lamp, and the like. In addition, from the viewpoint of making the projection device 31 have a small size, as the kind of the light source 41, the LED is preferably selected.

### (3-2-2. Modulation Unit)

The modulation unit 43 includes one or more lenses 63. For example, when light emitted from the light source 41 is projected to the screen or the like, which is located outside the projection device 31, through the modulation element 65 and the one or more lenses 63, an image of the projection image is projected on the screen or the like.

As described above, among the one or more lenses 63, at least one lens has substantially the same configuration as the optical element 21 according to the second embodiment. That is, for example, the lens 61 is provided with the lens base body 9 corresponding to the light-transmissive base body 7, and the optical laminated body 1. The lens 61 is provided with the optical laminated body 1 on the main surface of the lens base body 9, and thus the lens 61 has a low reflectance and a high transmittance with respect to incident light.

The modulation unit 43 includes the modulation element 65 as necessary. For example, the modulation element 65 is constituted by one or more liquid crystal displays (LCDs), an optical semiconductor in which a minute-mirror group, which is called DLP (registered trademark of Texas Instruments Incorporated) chip, is disposed, or the like.

FIG. 4A shows a schematic diagram illustrating a configuration example of a modulation unit.

FIG. 4A shows a diagram illustrating an example in which a modulation element 65a is constituted by “DLP (registered trademark)” chip. As shown in FIG. 4A, a modulation unit 43a is provided with, for example, lenses 61a, 61b, and 61c, a circular plate-shaped color filter Cw, the modulation element 65a, and a light absorbing body Ab. In addition, in FIG. 4A, the number of lenses making up the one or more lenses 63 is illustrated as three, but the drawing indicated by FIG. 4A is just an example, and the number of lenses making up the one or more lenses 63 is not limited to three.

Among the lenses 61a, 61b, and 61c, at least one is constituted by a lens having substantially the same configuration as the optical element 21 according to the second embodiment. For example, the color filter Cw has a configuration in which filters obtained by dividing a circular plate into three pieces are assembled. For example, the color filter Cw is constituted by assembling three blue, green, and red filters. The color filter Cw is disposed to be orthogonal to the paper plane, and is rotatably supported with a rotational axis Ra made as the center within a plane orthogonal to the paper plane.

As shown in FIG. 4A, light emitted from the light source 41 is incident to the color filter Cw through the lens 61a. Light transmitted through the color filter Cw is incident to the modulation element 65a through the lens 61b.

At this time, a color of the light transmitted through the color filter Cw becomes, for example, a color corresponding to a rotation angle of the color filter. That is, when the color filter Cw rotates, colors of the light incident to the modulation element 65a are sequentially switched with each other.

Each of the minute mirrors, which are disposed on a surface of the modulation element 65a, is configured in such a manner that an inclination thereof may be changed in correspondence with a driving signal supplied from the driver 75. That is, the modulation element 65a is configured in such a manner that a direction of reflecting light incident to each of the mirrors may be changed to a direction of the light absorbing body Ab or a direction of the lens 61c. Accordingly, when a rotational speed of the color filter Cw and the inclination of each of the minute mirrors that are disposed on a surface of the modulation element 65a are controlled, the image information related to the projection image may be overlapped on the light emitted from the light source 41.

Light reflected toward the direction of the lens 61c is emitted to the outside of the projection device 31 through the lens 61c. Accordingly, an image of the projection image is imaged on, for example, a screen.

FIG. 4B shows a schematic diagram illustrating another configuration example of the modulation unit.

FIG. 4B shows a diagram illustrating an example in which a modulation element 65b is constituted by a reflective liquid crystal display. As shown in FIG. 4B, a modulation unit 43b is provided with, for example, lenses 61d, 61e, and 61f, a prism (beam splitter) P, and the modulation element 65b. In addition, in FIG. 4B, the number of lenses making up the one or more lenses 63 is illustrated as three, but the drawing indicated by FIG. 4B is illustrative only, and the number of lenses making up the one or more lenses 63 is not limited to three.

Among the lenses, 61d, 61e, and 61f, at least one is constituted by a lens having substantially the same configuration as the optical element 21 according to the second embodiment.

As shown in FIG. 4B, for example, light emitted from the light source 41 is incident to the prism P through the lenses 61d and 61e. Light transmitted through the prism P is incident to the modulation element 65b.

Light incident to the modulation element 65b is reflected by the modulation element 65b, and is emitted toward the prism P after image information related to a projection image is overlapped thereon.

The light incident to the prism P after being reflected by the modulation element 65b is reflected at the inside of the prism. P, and the light reflected at the inside of the prism P is emitted toward a direction of the lens 61f. The light emitted toward the direction of the lens 61f is emitted to the outside of the projection device 31 through the lens 61f. Accordingly, an image of the projection image is imaged on, for example, a screen.

In addition, when the projection image is composed of a color image, for example, a color filter may be disposed on a modulation element 65b side, or the light emitted from the light source 41 may be subjected to color separation by a dichroic mirror or the like, and then may be incident to a modulation element corresponding to each color.

As described above, for example, when the light emitted from one or more light sources 41 is reflected by one or more liquid crystal displays, “DLP (registered trademark)” chips, or the like, image information related to the projection image is overlapped on the light emitted from the light sources 41. Alternatively, for example, when the light emitted from the light source 41 passes through the one or more liquid crystal displays, the image information related to the projection image is overlapped on the light emitted from the light source 41. In addition, for example, when the light source 41 is provided with a group of minute light sources corresponding to the number of pixels and the projection image is generated, the modulation element 65 may not be necessary.

In the third embodiment, the projection device is provided with the lenses having substantially the same configuration as the optical element according to the second embodiment, and an image of the projection image is imaged through the lenses having substantially the same configuration as the optical element according to the second embodiment.

As described above, deterioration of an image quality due to occurrence of the ghost becomes significant when the projection device has a small size. Therefore, with regard to an optical laminated body used in the small-sized projection device, a relatively low reflectance is demanded compared to a general antireflection film.

Conversely, in the third embodiment of the present disclosure, the optical laminated body formed on the main surface of the lens base body has a relatively low reflectance and a relatively high transmittance compared to a general antireflection film. Accordingly, according to the third embodiment, occurrence of the ghost is effectively suppressed, and a small-sized projection device may be provided.

### EXAMPLES

Hereinafter, the present disclosure will be described in detail with reference to examples, but the present disclosure is not limited to these examples. In the following examples, with respect to each of a case in which a kind of metals that constitute the metallic layer is changed, a case in which the thickness of the metallic layer is changed, and a case in which the thickness of the layer that is located at a position farthest from the dielectric layer is changed, the reflectance and transmittance of the optical laminated body were obtained by simulation. The simulation was performed by using optical simulation software TFCalc manufactured by Software Spectra, Inc.

### Example 1-A

In the following Example 1-A, the simulation was performed assuming that the number of layers of the optical laminated body was four, and the reflectance and the transmittance of the optical laminated body were obtained by the simulation in a case where the kind of metals constituting the metallic layer was changed.

### Test Example 1-1

The optical laminated body including the dielectric layer, the metallic layer, the high-refractive-index layer, and the low-refractive-index layer was assumed. As materials constituting the dielectric layer, the metallic layer, the high-refractive-index layer, and the low-refractive-index layer, SiO₂, Ag, TiO₂, and SiO₂ were assumed, respectively.

Details of a configuration of the optical laminated body of Test Example 1-1 are shown below.

Layer Configuration: (surface exposed to air)/dielectric layer/metallic layer/high-refractive-index layer/low-refractive-index layer

Dielectric layer: refractive index . . . 1.479, and layer thickness . . . 78.0 nm

Metallic layer: complex refractive index . . . 0.049-2.885i, and layer thickness . . . 6.5 nm

High-refractive-index layer: refractive index . . . 2.291, and layer thickness . . . 22.2 nm

Low-refractive-index layer: refractive index . . . 1.479, and layer thickness . . . 172.1 nm

### Comparative Example 1-1

An optical laminated body of Comparative Example 1-1 was assumed in the same manner as the optical laminated body of Test Example 1-1 except that Al was assumed as the material constituting the metallic layer, and the complex refractive index was set to 0.82-5.99i.

### Comparative Example 1-2

An optical laminated body of Comparative Example 1-2 was assumed in the same manner as the optical laminated body of Test Example 1-1 except that Cr was assumed as the material constituting the metallic layer, and the complex refractive index was set to 3.18-4.41i.

### Comparative Example 1-3

An optical laminated body of Comparative Example 1-3 was assumed in the same manner as the optical laminated body of Test Example 1-1 except that Ti was assumed as the material constituting the metallic layer, and the complex refractive index was set to 2.54-3.43i.

### Comparative Example 1-4

An optical laminated body of Comparative Example 1-4 was assumed in the same manner as the optical laminated body of Test Example 1-1 except that Nb (niobium) was assumed as the material constituting the metallic layer, and the complex refractive index was set to 1.95-2.56i.

### [Evaluation of Optical Characteristics]

A reflectance and a transmittance were obtained with respect to the optical laminated bodies of Test Example 1-1, and Comparative Examples 1-1, 1-2, 1-3, and 1-4, respectively.

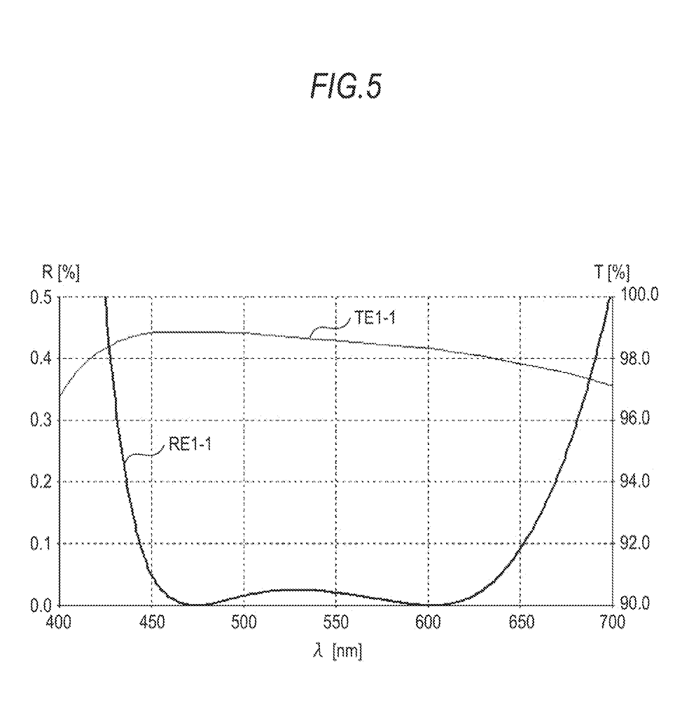

FIG. 5 shows a diagram illustrating a simulation result with respect to the optical laminated body of Test Example 1-1.

The horizontal axis of a graph shown in FIG. 5 represents a wavelength λ [nm] of incident light, the left vertical axis of the graph shown in FIG. 5 represents a reflectance R [%], and the right vertical axis of the graph shown in FIG. 5 represents a transmittance T [%]. These are true of the following description.

A curve RE1-1 in FIG. 5 represents the simulation result about the reflectance of the optical laminated body of Test Example 1-1, and a curve TE1-1 in FIG. 5 represents the simulation result about the transmittance of the optical laminated body of Test Example 1-1.

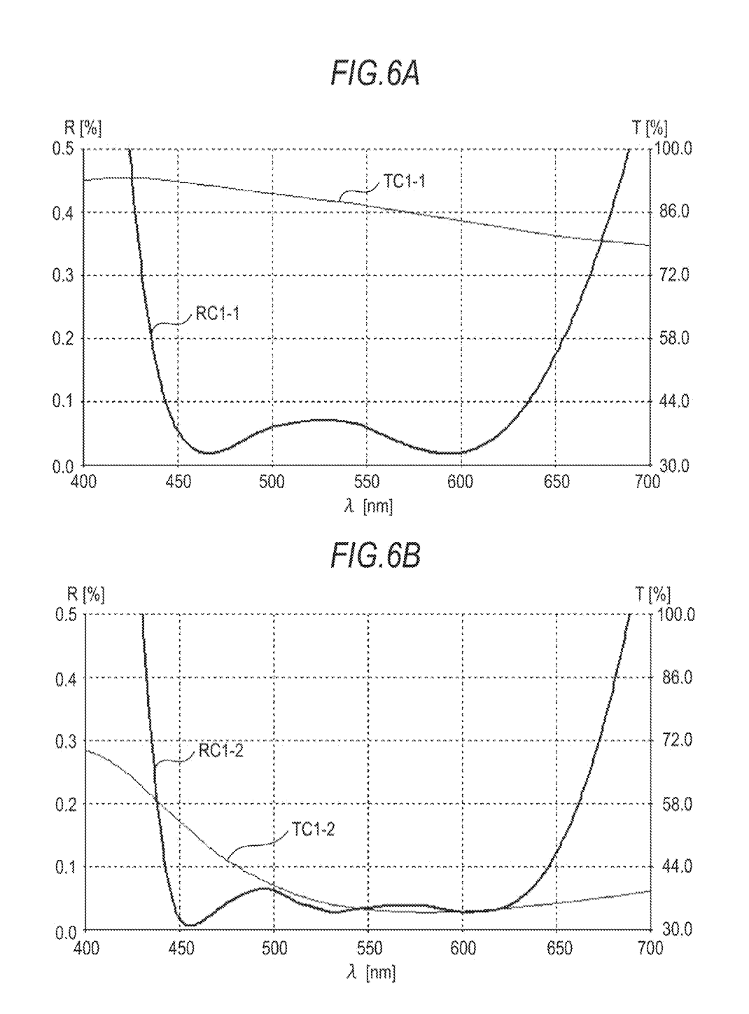

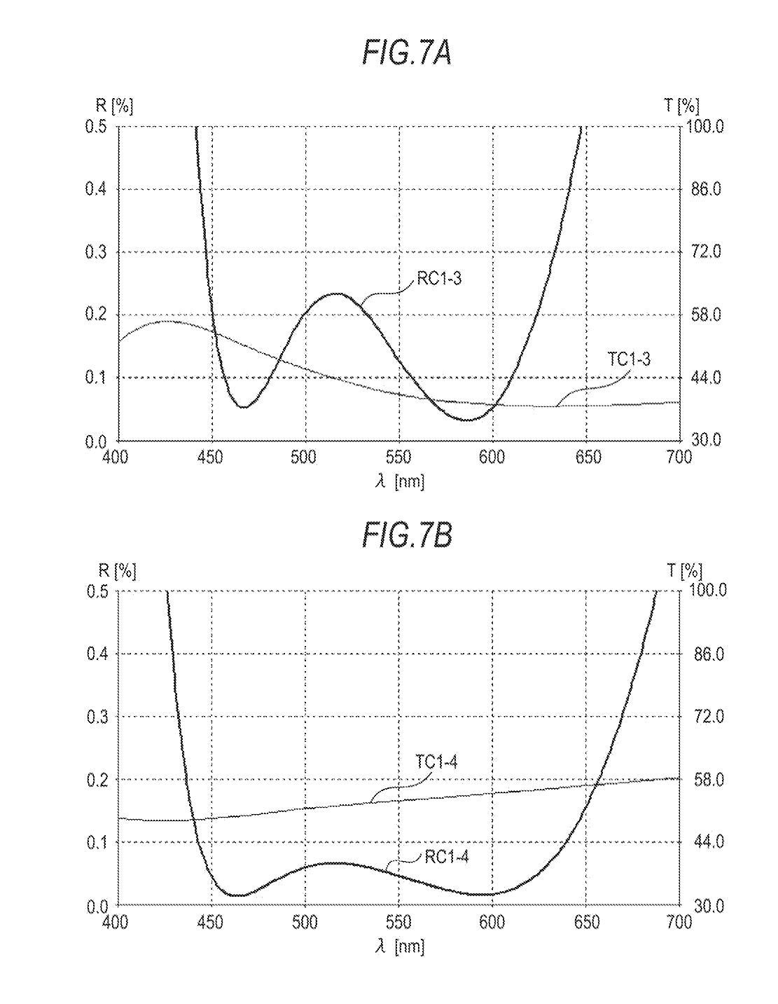

FIG. 6A shows a diagram illustrating a simulation result with respect to the optical laminated body of Comparative Example 1-1. FIG. 6B shows a diagram illustrating a simulation result with respect to the optical laminated body of Comparative Example 1-2. FIG. 7A shows a diagram illustrating a simulation result with respect to the optical laminated body of Comparative Example 1-3. FIG. 7B shows a diagram illustrating a simulation result with respect to the optical laminated body of Comparative Example 1-4.

A curve RC1-1 in FIG. 6A represents the simulation result about the reflectance of the optical laminated body of Comparative Example 1-1, and a curve TC1-1 in FIG. 6A represents the simulation result about the transmittance of the optical laminated body of Comparative Example 1-1. A curve RC1-2 in FIG. 6B represents the simulation result about the reflectance of the optical laminated body of Comparative Example 1-2, and a curve TC1-2 in FIG. 6B represents the simulation result about the transmittance of the optical laminated body of Comparative Example 1-2. A curve RC1-3 in FIG. 7A represents the simulation result about the reflectance of the optical laminated body of Comparative Example 1-3, and a curve TC1-3 in FIG. 7A represents the simulation result about the transmittance of the optical laminated body of Comparative Example 1-3. A curve RC1-4 in FIG. 7B represents the simulation result about the reflectance of the optical laminated body of Comparative Example 1-4, and a curve TC1-4 in FIG. 7B represents the simulation result about the transmittance of the optical laminated body of Comparative Example 1-4.

From FIGS. 5, 6A, 6B, 7A, and 7B, the following description could be understood.

In the optical laminated body of Test Example 1-1, the reflectance in a visible region was suppressed to approximately 0.03%. As described above, in the optical laminated body of Test Example 1-1 in which Ag was selected as the material constituting the metallic layer, a reflectance of 0.1% or less and a transmittance of 90% or more were obtained in the visible light region.

On the other hand, in the optical laminated bodies of Comparatives Examples 1-1 to 1-4 in which a metal other than Ag was selected for the metallic layer, it could be understood that it is difficult to realize compatibility between a low reflectance and a high transmittance. For example, in the case of using Al, the transmittance in the visible light region did not reach 90%, and the reflectance did not reach a value in the case of using Ag. In a case of using Cr, Ti, or Nb, the transmittance decreases to approximately 30% to 40%.

Accordingly, when the metallic layer containing at least Ag was disposed adjacently to the layer having the surface exposed to air, it could be understood that the low reflectance and the high transmittance may be compatible with each other even in a layer configuration of four layers less than that of a general antireflection film. For example, when optical design of the optical laminated body was carried out by disposing the metallic layer constituted by Ag adjacently to the layer having the surface exposed to air, it could be understood that a reflectance of 0.1% or less may be obtained in a wavelength region of 460 to 650 nm.

In addition, the reflectance and the transmittance of the optical laminated body may be measured by a spectrophotometer. Hereinafter, an example of a device, which measures the reflectance and transmittance of the optical laminated body, is shown.

Measurement device: Spectrophotometer (U-4100; manufactured by Hitachi High-Technologies Corporation)

Measurement conditions: conditions compliant to JIS-R-3106

The thickness of each of layers of the optical laminated body may be obtained by observing a cross-section of the optical laminated body with a transmission electron microscope (TEM).

### Example 2-A

In the following Example 2-A, simulation was carried out by assuming that the number of layers of the optical laminated body was four, and the reflectance of the optical laminated body in a case of changing the thickness of the metallic layer constituted by a Ag layer was obtained by simulation.

### Test Example 2-1

An optical laminated body, which is the same as the optical laminated body of Test Example 1-1 in Example 1-A, was assumed. That is, an optical laminated body including the dielectric layer, the metallic layer, the high-refractive-index layer, and the low-refractive-index layer was assumed, and as materials constituting the dielectric layer, the metallic layer, the high-refractive-index layer, and the low-refractive-index layer, SiO₂, Ag, TiO₂, and SiO₂ were assumed, respectively.

Details of a configuration of the optical laminated body of Test Example 2-1 are shown below.

Layer Configuration: (surface exposed to air)/dielectric layer/metallic layer/high-refractive-index layer/low-refractive-index layer

Dielectric layer: refractive index . . . 1.479, and layer thickness . . . 78.0 nm

Metallic layer: complex refractive index . . . 0.049-2.885i, and layer thickness . . . 6.5 nm

High-refractive-index layer: refractive index . . . 2.291, and layer thickness . . . 22.2 nm

Low-refractive-index layer: refractive index . . . 1.479, and layer thickness . . . 172.1 nm

### Test Example 2-2

An optical laminated body of Test Example 2-2 was assumed in the same manner as the optical laminated body of Test Example 2-1 except that the layer thickness of the metallic layer was set to 6.1 nm.

### Comparative Example 2-1

An optical laminated body of Comparative Example 2-1 was assumed in the same manner as the optical laminated body of Test Example 2-1 except that the layer thickness of the metallic layer was set to 5 nm.

### Comparative Example 2-2

An optical laminated body of Comparative Example 2-2 was assumed in the same manner as the optical laminated body of Test Example 2-1 except that the layer thickness of the metallic layer was set to 10 nm.

### Comparative Example 2-3

An optical laminated body of Comparative Example 2-3 was assumed in the same manner as the optical laminated body of Test Example 2-1 except that the layer thickness of the metallic layer was set to 6 nm.

### Comparative Example 2-4

An optical laminated body of Comparative Example 2-4 was assumed in the same manner as the optical laminated body of Test Example 2-1 except that the layer thickness of the metallic layer was set to 6.6 nm.

### [Evaluation of Optical Characteristics]

A reflectance and a transmittance were obtained with respect to the optical laminated bodies of Test Example 2-1, and Comparative Examples 2-1 and 2-2, respectively. In addition, a reflectance was obtained with respect to the optical laminated bodies of Test Example 2-2, and Comparative Examples 2-3 and 2-4, respectively.

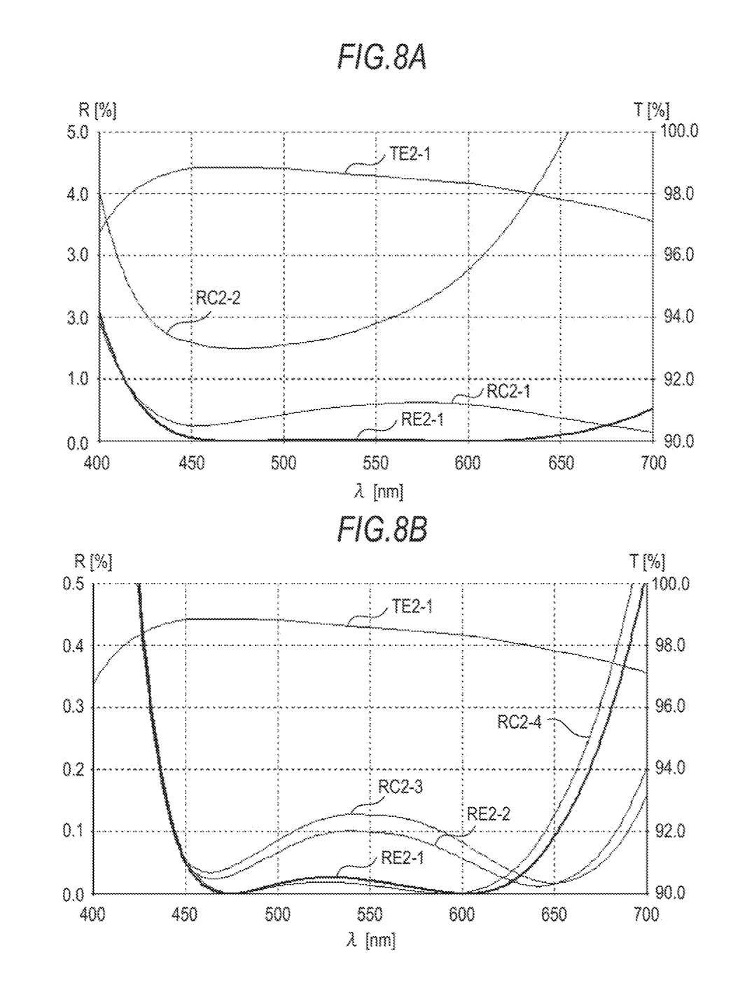

FIG. 8A shows a diagram illustrating simulation results with respect to the optical laminated bodies of Test Example 2-1, and Comparative Examples 2-1 and 2-2.

A curve RE2-1 in FIG. 8A represents the simulation result about the reflectance of the optical laminated body of Test Example 2-1, and a curve TE2-1 in FIG. 8A represents the simulation result about the transmittance of the optical laminated body of Test Example 2-1. A curve RC2-1 in FIG. 8A represents the simulation result about the reflectance of the optical laminated body of Comparative Example 2-1, and a curve RC2-2 in FIG. 8A represents the simulation result about the reflectance of the optical laminated body of Comparative Example 2-2.

FIG. 8B shows a diagram illustrating simulation results with respect to the optical laminated bodies of Test Example 2-2, and Comparative Examples 2-3 and 2-4.

A curve RE2-2 in FIG. 8B represents the simulation result about the reflectance of the optical laminated body of Test Example 2-2, a curve RC2-3 in FIG. 8B represents the simulation result about the reflectance of the optical laminated body of Comparative Example 2-3, and a curve RC2-4 in FIG. 8B represents the simulation result about the reflectance of the optical laminated body of Comparative Example 2-4. In addition, the simulation results of the reflectance and the transmittance of the optical laminated body of Test Example 2-1 were shown together in FIG. 8B.

From FIGS. 8A and 8B, the following description could be understood.

In the optical laminated body of Test Example 2-1 in which the thickness of the metallic layer formed from Ag was set to 6.5 nm, a reflectance of 0.1% or less and a transmittance of 90% or more were obtained in the visible light region. In addition, in the optical laminated body of Test Example 2-2 in which the thickness of the metallic layer formed from Ag was set to 6.1 nm, a reflectance of 0.1% or less was obtained in the visible light region.

On the other hand, in the optical laminated bodies of Comparative Example 2-1 in which the thickness of the metallic layer formed from Ag was set to 5 nm, and Comparative Example 2-2 in which the thickness of the metallic layer formed from Ag was set to 10 nm, it could be understood that it is difficult to obtain a reflectance of 0.1% or less in the visible light region. In addition, in the optical laminated bodies of Comparative Example 2-3 in which the thickness of the metallic layer formed from Ag was set to 6 nm, and Comparative Example 2-4 in which the thickness of the metallic layer formed from Ag was set to 6.6 nm, it could be understood that it is difficult to obtain a reflectance of 0.1% or less in the visible light region.

That is, it could be understood that it is effective to set the thickness of the metallic layer to 6.1 to 6.5 nm so as to obtain a low reflectance in a case where the number of layers of the optical laminated body was set to four.

### Example 3-A

In the following Example 3-A, simulation was carried out by assuming that the number of layers of the optical laminated body was four, and the reflectance of the optical laminated body in a case where a layer located at a position farthest from the dielectric layer was constituted by a low-refractive-index layer, and the thickness of the low-refractive-index layer was changed was obtained by simulation.

### Test Example 3-1

An optical laminated body, which is the same as the optical laminated body of Test Example 1-1 in Example 1-A, was assumed. That is, an optical laminated body including the dielectric layer, the metallic layer, the high-refractive-index layer, and the low-refractive-index layer was assumed, and as materials constituting the dielectric layer, the metallic layer, the high-refractive-index layer, and the low-refractive-index layer, SiO₂, Ag, TiO₂, and SiO₂ were assumed, respectively.

Details of a configuration of the optical laminated body of Test Example 3-1 are shown below.

Layer Configuration: (surface exposed to air)/dielectric layer/metallic layer/high-refractive-index layer/low-refractive-index layer

Dielectric layer: refractive index . . . 1.479, and layer thickness . . . 78.0 nm

Metallic layer: complex refractive index . . . 0.049-2.885i, and layer thickness . . . 6.5 nm

High-refractive-index layer: refractive index . . . 2.291, and layer thickness . . . 22.2 nm

Low-refractive-index layer: refractive index . . . 1.479, and layer thickness . . . 172.1 nm

### Test Example 3-2

An optical laminated body of Test Example 3-2 was assumed in the same manner as the optical laminated body of Test Example 3-1 except that the layer thickness of the low-refractive-index layer was set to 150 nm.

### Comparative Example 3-1

An optical laminated body of Comparative Example 3-1 was assumed in the same manner as the optical laminated body of Test Example 3-1 except that the layer thickness of the low-refractive-index layer was set to 50 nm.

### Comparative Example 3-2

An optical laminated body of Comparative Example 3-2 was assumed in the same manner as the optical laminated body of Test Example 3-1 except that the layer thickness of the low-refractive-index layer was set to 100 nm.

### Reference Example 3-1

An optical laminated body, which is substantially the same as the optical laminated body of Test Example 1-1 in Example 1-A except that the layer thickness of the low-refractive-index layer was set to 348.2 nm, was assumed. Details of a configuration of the optical laminated body of Reference Example 3-1 are shown below.

Layer Configuration: (surface exposed to air)/dielectric layer/metallic layer/high-refractive-index layer/low-refractive-index layer

Dielectric layer: refractive index . . . 1.479, and layer thickness . . . 77.4 nm

Metallic layer: complex refractive index . . . 0.049-2.885i, and layer thickness . . . 6.7 nm

High-refractive-index layer: refractive index . . . 2.291, and layer thickness . . . 22.1 nm

Low-refractive-index layer: refractive index . . . 1.479, and layer thickness . . . 348.2 nm

### [Evaluation of Optical Characteristics]

A reflectance and a transmittance were obtained with respect to the optical laminated bodies of Test Examples 3-1 and 3-2, Comparative Examples 3-1 and 3-2, and Reference Example 3-1, respectively.

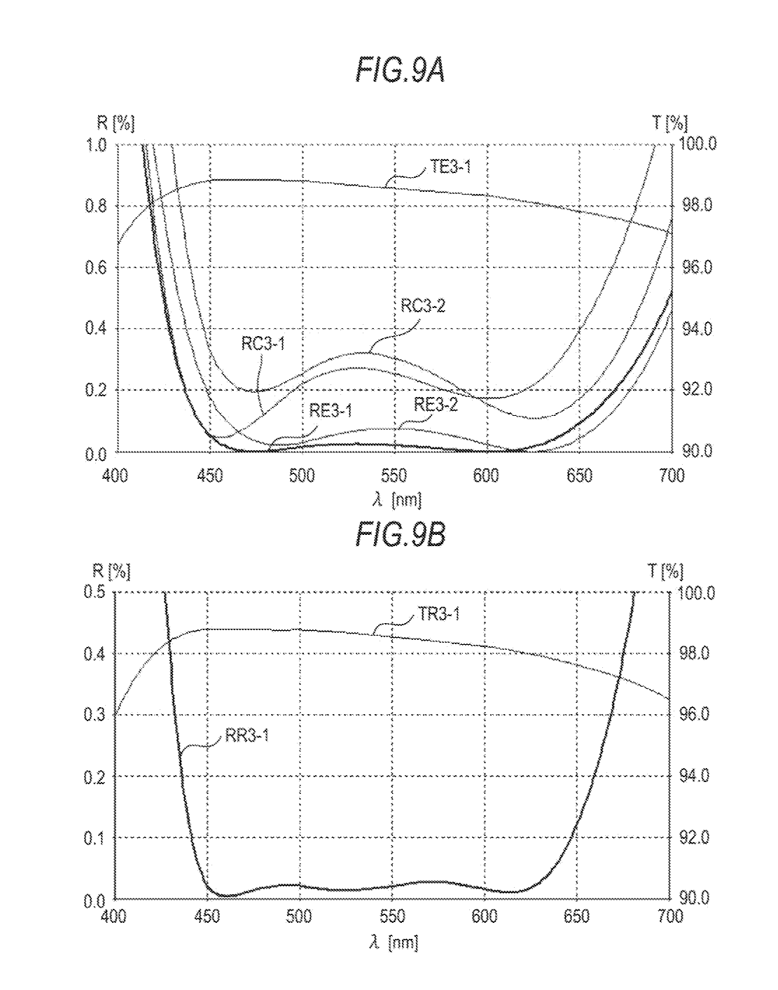

FIG. 9A shows a diagram illustrating simulation results with respect to the optical laminated bodies of Test Examples 3-1 and 3-2, and Comparative Examples 3-1 and 3-2.

A curve RE3-1 in FIG. 9A represents the simulation result about the reflectance of the optical laminated body of Test Example 3-1, and a curve TE3-1 in FIG. 9A represents the simulation result about the transmittance of the optical laminated body of Test Example 3-1. A curve RE3-2 in FIG. 9A represents the simulation result about the reflectance of the optical laminated body of Test Example 3-2. A curve RC3-1 in FIG. 9A represents the simulation result about the reflectance of the optical laminated body of Comparative Example 3-1, and a curve RC3-2 in FIG. 9A represents the simulation result about the reflectance of the optical laminated body of Comparative Example 3-2.

FIG. 9B shows a diagram illustrating the simulation result with respect to the optical laminated body of Reference Example 3-1.

A curve RR3-1 in FIG. 9B represents the simulation result about the reflectance of the optical laminated body of Reference Example 3-1, and a curve TR3-1 in FIG. 9B represents the simulation result about the transmittance of the optical laminated body of Reference Example 3-1.

From FIGS. 9A and 9B, the following description could be understood.

In the optical laminated body of Test Example 3-1 in which the thickness of the low-refractive-index layer was set to approximately 170 nm, a reflectance of 0.1% or less and a transmittance of 90% or more were obtained in the visible light region. In addition, in the optical laminated body of Test Example 3-2 in which the thickness of the low-refractive-index layer was set to approximately 150 nm, a reflectance of 0.1% or less was obtained in a wavelength region of 460 to 650 nm.

On the other hand, in the optical laminated bodies of Comparative Examples 3-1 and 3-2 in which the thickness of the low-refractive-index layer was less than 150 nm, it could be understood that it is difficult to obtain a low reflectance in the entirety the wavelength region of 460 to 650 nm.

In addition, in the optical laminated body of Reference Example 3-1 in which the thickness of the low-refractive-index layer was set to approximately 340 nm, a reflectance of 0.1% or less and a transmittance of 90% or more were obtained in the entirety of the visible light region. Furthermore, the optical laminated body of Reference Example 3-1 had the minimum reflectance near a wavelength corresponding to a wavelength of light emitted from, for example, each of blue, green, and red LEDs, and a transmittance in the visible region was as high as 98%.

That is, for example, a reflectance near a peak wavelength of the LED may be selectively lowered by constituting a layer located at a position farthest from the dielectric layer by a low-refractive-index layer and by changing the thickness of the low-refractive-index layer. At this time, from the viewpoints of preventing the manufacturing cost or lead time from increasing, it is preferable that the thickness of the low-refractive-index layer located at a position farthest from the dielectric layer be set to be equal to or more than 150 nm and less than 510 nm.

### Example 1-B

In the following Example 1-B, simulation was carried out by assuming that the number of layers of the optical laminated body was six, and the reflectance and the transmittance of the optical laminated body were obtained by simulation. Furthermore, the reflectance and the transmittance of the optical laminated body in a case of changing the thickness of the metallic layer constituted by an Ag layer were obtained by simulation.

### Test Example 4-1

An optical laminated body including the dielectric layer, the metallic layer, the high-refractive-index layer H₁, the low-refractive-index layer L₁, the high-refractive-index layer H₀, and the low-refractive-index layer L₀ was assumed. As materials constituting the dielectric layer, the metallic layer, the high-refractive-index layer, and the low-refractive-index layer, SiO₂, Ag, TiO₂, and SiO₂ were assumed, respectively.

Details of a configuration of the optical laminated body of Test Example 4-1 are shown below.

Layer Configuration: (surface exposed to air)/dielectric layer/metallic layer/high-refractive-index layer H₁/low-refractive-index layer L₁/high-refractive-index layer H₀/low-refractive-index layer L₀

Dielectric layer: refractive index . . . 1.479, and layer thickness . . . 78.9 nm

Metallic layer: complex refractive index . . . 0.049-2.885i, and layer thickness . . . 5.9 nm

High-refractive-index layer H₁: refractive index . . . 2.291, and layer thickness . . . 23.2 nm

Low-refractive-index layer L₁: refractive index . . . 1.479, and layer thickness . . . 65.6 nm

High-refractive-index layer H₀: refractive index . . . 2.291, and layer thickness . . . 3.0 nm

Low-refractive-index layer L₀: refractive index . . . 1.479, and layer thickness . . . 86.5 nm

### Test Example 4-2

An optical laminated body of Test Example 4-2 was assumed in the same manner as the optical laminated body of Test Example 4-1 except that the layer thickness of the metallic layer was set to 5.5 nm.

### Test Example 4-3

An optical laminated body of Test Example 4-3 was assumed in the same manner as the optical laminated body of Test Example 4-1 except that the layer thickness of the metallic layer was set to 6.2 nm.

### Comparative Example 4-1

An optical laminated body of Comparative Example 4-1 was assumed in the same manner as the optical laminated body of Test Example 4-1 except that the layer thickness of the metallic layer was set to 5.4 nm.

### Comparative Example 4-2

An optical laminated body of Comparative Example 4-2 was assumed in the same manner as the optical laminated body of Test Example 4-1 except that the layer thickness of the metallic layer was set to 6.3 nm.

### Test Example 4-4

An optical laminated body in which a layer located at a position farthest from the dielectric layer was constituted by a high-refractive index layer, and which included the dielectric layer, the metallic layer, the low-refractive-index layer L₁, high-refractive-index layer H₁, layer H₀ was assumed. As materials constituting the dielectric layer, the metallic layer, the low-refractive-index layer, and the high-refractive-index layer, SiO₂, Ag, SiO₂, and TiO₂ were assumed, respectively.

Details of a configuration of the optical laminated body of Test Example 4-4 are shown below.

Layer Configuration: (surface exposed to air)/dielectric layer/metallic layer/low-refractive-index layer L₁/high-refractive-index layer H₂/low-refractive-index layer L₀/high-refractive-index layer H₀

Dielectric layer: refractive index . . . 1.479, and layer thickness . . . 61.1 nm

Metallic layer: complex refractive index . . . 0.049-2.885i, and layer thickness . . . 6.1 nm

Low-refractive-index layer L₁: refractive index . . . 1.479, and layer thickness . . . 149.1 nm

High-refractive-index layer H₁: refractive index . . . 2.291, and layer thickness . . . 113.4 nm

Low-refractive-index layer L₀: refractive index . . . 1.479, and layer thickness . . . 34.6 nm

High-refractive-index layer H₀: refractive index . . . 2.291, and layer thickness . . . 11.1 nm

### [Evaluation of Optical Characteristics]

A reflectance and a transmittance were obtained with respect to the optical laminated bodies of Test Examples 4-1 to 4-4, and Comparative Examples 4-1 and 4-2, respectively.

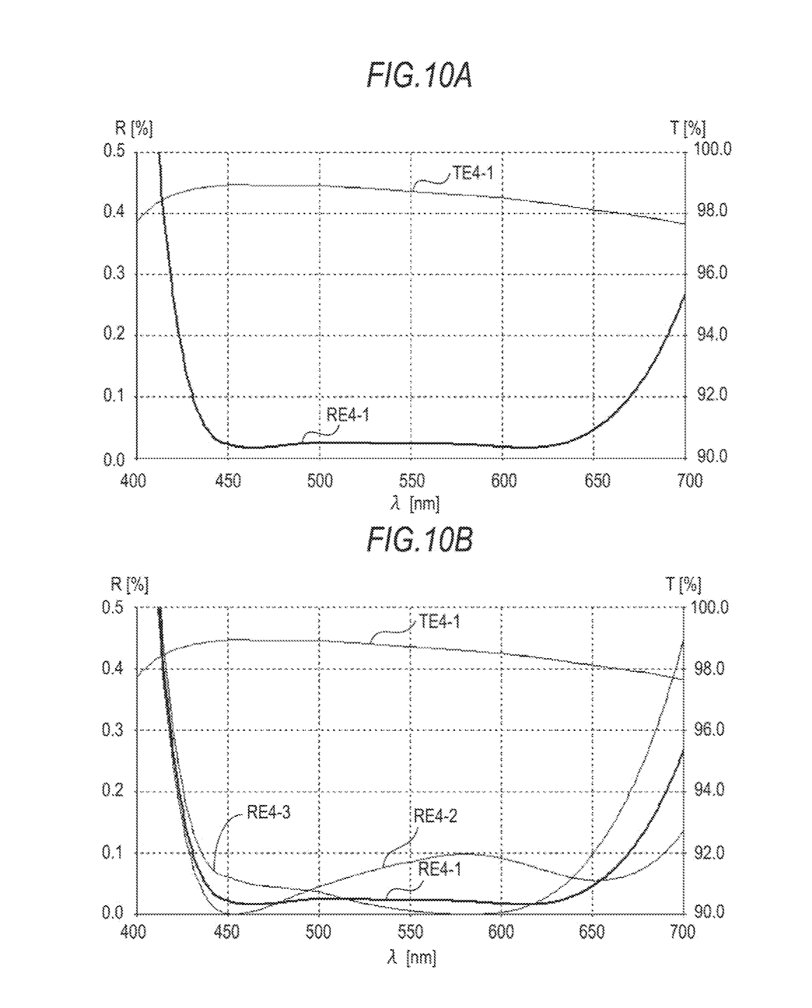

FIG. 10A shows a diagram illustrating a simulation results with respect to the optical laminated body of Test Example 4-1.

A curve RE4-1 in FIG. 10A represents the simulation result about the reflectance of the optical laminated body of Test Example 4-1, and a curve TE4-1 in FIG. 10A represents the simulation result about the transmittance of the optical laminated body of Test Example 4-1.

FIG. 10B shows a diagram illustrating simulation results of the optical laminated bodies of Test Examples 4-2 and 4-3.

A curve RE4-2 in FIG. 10B represents the simulation result about the reflectance of the optical laminated body of Test Example 4-2. A curve RE4-3 in FIG. 10B represents the simulation result about the reflectance of the optical laminated body of Test Example 4-3. In addition, the simulation results of the reflectance and the transmittance of the optical laminated body of Test Example 4-1 were shown together in FIG. 10B.

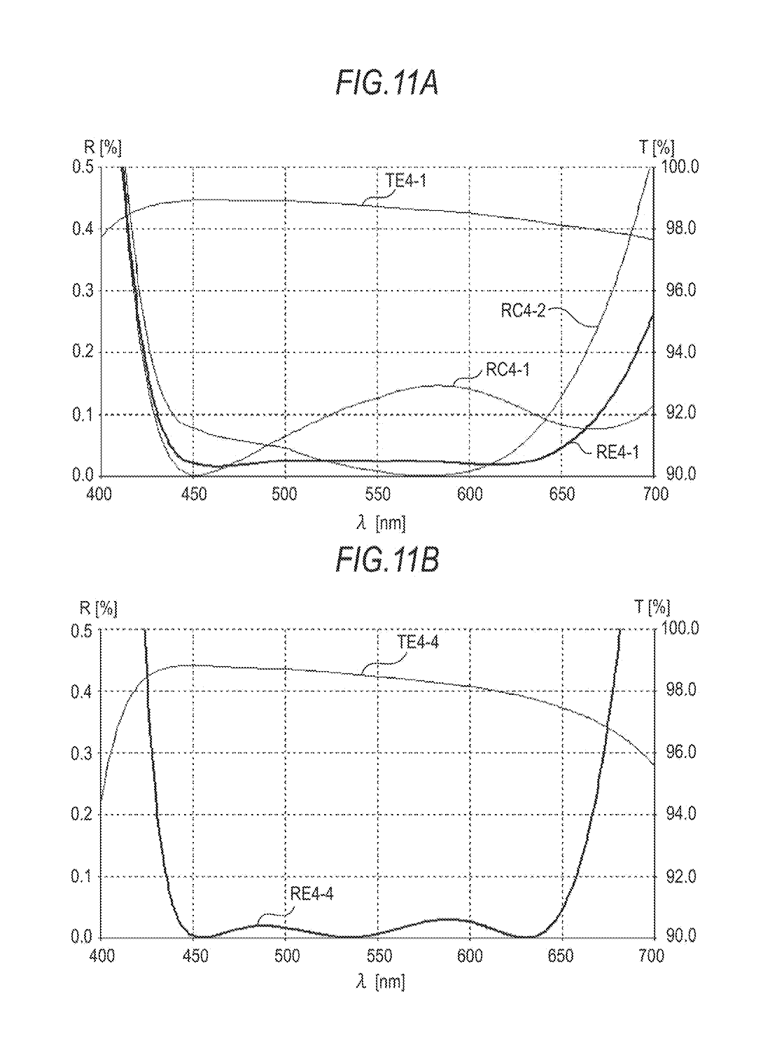

FIG. 11A shows a diagram illustrating simulation results of the optical laminated bodies of Comparative Examples 4-1 and 4-2.

A curve RC4-1 in FIG. 11A represents the simulation result about the reflectance of the optical laminated body of Comparative Example 4-1. A curve RC4-2 in FIG. 11A represents the simulation result about the reflectance of the optical laminated body of Comparative Example 4-2. In addition, the simulation results of the reflectance and the transmittance of the optical laminated body of Test Example 4-1 were shown together in FIG. 11A.

FIG. 11B shows a diagram illustrating the simulation result with respect to the optical laminated body of Test Example 4-4.

A curve RE4-4 in FIG. 11B represents the simulation result about the reflectance of the optical laminated body of Test Example 4-4. A curve TE4-4 in FIG. 11B represents the simulation result about the transmittance of the optical laminated body of Test Example 4-4.

From FIGS. 10A, 10B, 11A, and 11B, the following description could be understood.

In the optical laminated body of Test Example 4-1 in which the number of layers of the optical laminated body was set to six, and the thickness of the metallic layer was set to 5.9 nm, the reflectance in the visible light region was lowered to approximately 0.02%. Furthermore, the transmittance in the visible light region was as high as 98%. That is, in the optical laminated body of Test Example 4-1 in which the thickness of the metallic layer was set to 5.9 nm, it could be understood that a reflectance of 0.1% or less and a transmittance of 90% or more may be obtained in the visible light region.

In addition, even in the optical laminated bodies of Test Example 4-2 in which the number of layers of the optical laminated body was set to six and the thickness of the metallic layer was set to 5.5 nm, and Test Example 4-3 in which the number of layers of the optical laminated body was set to six and the thickness of the metallic layer was set to 6.2 nm, a reflectance of 0.1% or less was obtained in the visible light region.

On the other hand, in the optical laminated bodies of Comparative Example 4-1 in which the thickness of the metallic layer formed from Ag was set to 5.4 nm and Comparative Example 4-2 in which the thickness of the metallic layer formed from Ag was set to 6.3 nm, it could be understood that it is difficult to obtain a reflectance of 0.1% or less in the visible light region.

In addition, in the optical laminated body of Test Example 4-4 in which a layer located at a position farthest from the dielectric layer was constituted by a high-refractive-index layer and the thickness of the metallic layer was set to 6.1 nm, it could be understood that a reflectance of 0.1% or less and a transmittance of 90% or more may be obtained in the visible light region.

Furthermore, in the optical laminated body of Test Example 4-4, the reflectance was minimal near a wavelength of 470 nm, near a wavelength of 530 nm, and near a wavelength of 630 nm. In other words, a reflectance near a peak wavelength of each of blue, green, and red LEDs was approximately zero.

As described above, when the number of layers of the optical laminated body was set to six, and the metallic layer containing at least Ag was disposed adjacently to the layer having a surface exposed to air, it could be seen that a low reflectance may be obtained in a relatively wide wavelength region compared to a case in which the number of layer of the optical laminated body was set to four. At this time, it could be understood that it is preferable that the thickness of the metallic layer, which is disposed adjacently to the layer having the surface exposed to air and contains at least Ag, be set to 5.5 to 6.2 nm.

In addition, it could be understood that the reflectance near a peak wavelength of the light source may be selectively lowered by appropriately adjusting a layer configuration of the laminated body adjacent to the metallic layer. For example, in a case where light emitted from an LED light source is used through an optical laminated body, and the like, for prevention of reflection, it is effective to selectively lower a reflectance near the peak wavelength of the light source compared to a case of lowering the reflectance in the entirety of the visible light region.

### 4. Modification Example

Hereinbefore, preferred embodiments have been described, but preferred specific examples are not limited to the above-described examples, and various modifications may be made.

In the above-described embodiments, a projection device to which the technology of the present disclosure is applied has been illustrated, but the technology of the present disclosure is applicable to other electronic apparatuses. For example, the present disclosure is applicable to electronic apparatuses provided with an imaging optical system or a display device, and the like. For example, the present disclosure is applicable to a camera, a video camera, a smart phone, a cellular phone, an electronic book, a personal computer (a tablet type, a laptop type, and a desktop type), a personal digital assistance (PDA), a video gaming machine, a digital photo frame, a television receiver, and the like.

Furthermore, the technology of the present disclosure is applicable to, for example, an optical pickup in a recording and reproducing device of music or an image, an optical system of a microscope, an antireflective film of a solar cell, and the like.

The technology of the present disclosure is suitable for use in a small-sized projection device in which a relatively high transmittance is demanded with respect to an optical element compared to a general antireflection film. The technology of the present disclosure is suitable for imaging optical systems such as a small-sized portable projector, a camera provided with a projector, and a projector of a projection-type keyboard.

In addition, the configurations, the methods, the shapes, the materials, the dimensions, and the like, which are exemplified in the above-described embodiments, are illustrative only, and configuration, methods, shapes, materials, dimensions, and the like, which are different from the above-described configurations and the like, may be used as necessary. The configurations, the methods, the shapes, the materials, the dimensions, and the like of the above-described embodiments may be combined with each other as long as this combination does not depart from the gist of the present disclosure.

For example, the present disclosure may have the following configurations.

(1) An optical laminated body including: a dielectric layer having a surface exposed to air; a metallic layer that has an interface with the dielectric layer, and contains at least Ag; and a laminated body that has an interface with the metallic layer and includes one or more low-refractive-index layers and one or more high-refractive-index layers, wherein a reflectance in a wavelength region of 460 to 650 nm is 0.1% or less.

(2) The optical laminated body according to (1), wherein the laminated body includes two or more low-refractive-index layers and two or more high-refractive-index layers, and a reflectance in a visible light region is 0.1% or less.

(3) The optical laminated body according to (2), wherein a thickness of the metallic layer is set to 5.5 to 6.2 nm.

(4) The optical laminated body according to (1), wherein the laminated body includes one low-refractive-index layer and one-high-refractive-index layer, the one high-refractive-index layer has an interface with the metallic layer, and a thickness of the one low-refractive-index layer is set to be equal to or more than 150 nm and less than 510 nm.

(5) The optical laminated body according to (4), wherein a thickness of the metallic layer is set to 6.1 to 6.5 nm, and a reflectance in a visible light region is 0.1% or less.

(6) The optical laminated body according to any one of (1) to (5), wherein the metallic layer contains at least one or more kinds selected from a group consisting of Pd, Cu, Au, Nd, Sm, Bi, and Pt.

(7) The optical laminated body according to any one of (1) to (6), wherein a thickness of the dielectric layer is set to 100 nm or less.

(8) An optical element including: a dielectric layer having a surface exposed to air; a metallic layer that has an interface with the dielectric layer, and contains at least Ag; a laminated body that has an interface with the metallic layer and includes one or more low-refractive-index layers and one or more high-refractive-index layers; and a light-transmissive base body having an interface with the laminated body.

(9) The optical element according to (8), wherein in the low-refractive-index layer and the high-refractive-index layer that are included in the laminated body, a layer located at a farthest position from the dielectric layer is constituted by a low-refractive-index layer, and a thickness of the low-refractive-index layer is set to be equal to or more than 150 nm and less than 510 nm.

(10) A projection device including: a light source; and a modulation unit that includes one or more lenses, and overlaps image information on light emitted from the light source, wherein at least one lens among the one or more lenses includes a dielectric layer having a surface exposed to air, a metallic layer that has an interface with the dielectric layer and contains at least Ag, and a laminated body that has an interface with the metallic layer and includes one or more low-refractive-index layers and one or more high-refractive-index layers, and a lens base body having an interface with the laminated body.

The present disclosure contains subject matter related to that disclosed in Japanese Priority Patent Application JP 2012-111291 filed in the Japan Patent Office on May 15, 2012, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An optical laminated body comprising:
a dielectric layer having a surface exposed to air;
a metallic layer that has an interface with the dielectric layer, and contains at least Ag; and
a laminated body that has an interface with the metallic layer and includes one or more low-refractive-index layers and one or more high-refractive-index layers,
wherein a reflectance in a wavelength region of 460 to 650 nm is 0.1% or less.

2. The optical laminated body according to claim 1,
wherein the laminated body includes two or more low-refractive-index layers and two or more high-refractive-index layers, and
a reflectance in a visible light region is 0.1% or less.

3. The optical laminated body according to claim 2,
wherein a thickness of the metallic layer is set to 5.5 to 6.2 nm.

4. The optical laminated body according to claim 1,
wherein the laminated body includes one low-refractive-index layer and one high-refractive-index layer,
the one high-refractive-index layer has an interface with the metallic layer, and
a thickness of the one low-refractive-index layer is set to be equal to or more than 150 nm and less than 510 nm.

5. The optical laminated body according to claim 4,
wherein a thickness of the metallic layer is set to 6.1 to 6.5 nm, and
a reflectance in a visible light region is 0.1% or less.

6. The optical laminated body according to claim 1,
wherein the metallic layer contains at least one or more kinds selected from a group consisting of Pd, Cu, Au, Nd, Sm, Bi, and Pt.

7. The optical laminated body according to claim 1,
wherein a thickness of the dielectric layer is set to 100 nm or less.

8. An optical element comprising:
a dielectric layer having a surface exposed to air;
a metallic layer that has an interface with the dielectric layer, and contains at least Ag;
a laminated body that has an interface with the metallic layer and includes one or more low-refractive-index layers and one or more high-refractive-index layers; and
a light-transmissive base body having an interface with the laminated body.

9. The optical element according to claim 8,
wherein in the low-refractive-index layer and the high-refractive-index layer that are included in the laminated body, a layer located at a farthest position from the dielectric layer is constituted by a low-refractive-index layer, and
a thickness of the low-refractive-index layer is set to be equal to or more than 150 nm and less than 510 nm.

10. A projection device comprising:
a light source; and
a modulation unit that includes one or more lenses, and overlaps image information on light emitted from the light source,
wherein at least one lens among the one or more lenses includes
a dielectric layer having a surface exposed to air,
a metallic layer that has an interface with the dielectric layer and contains at least Ag, and
a laminated body that has an interface with the metallic layer and includes one or more low-refractive-index layers and one or more high-refractive-index layers, and
a lens base body having an interface with the laminated body.
